(19) United States
(12) Patent Application Publication
(10) Pub. No.: US 2004/0042033 A1
(43) Pub. Date: Mar. 4, 2004

(54) Display of location of alternate image-forming device to which image-forming-related job has been routed

(76) Inventors: Bob Sesek, Meridian, ID (US); Curtis Reese, Boise, ID (US); Chad Stevens, Boise, ID (US)

Correspondence Address: HEWLETT-PACKARD COMPANY, Intellectual Property Administration, P.O. Box 272400, Fort Collins, CO, 80627-2400, US

(21) Appl. No.: 10/229,691

(22) Filed: Aug. 28, 2002

(51) Int. Cl. G06F 3/12; G06F 15/00; G06F 13/00; G06F 11/30

(52) U.S. Cl. 358/1.15; 710/38; 709/239; 709/224; 710/16

(57) ABSTRACT

A method of an embodiment of the invention is disclosed that routes an image-forming-related job from an intended image-forming device to an alternate image-forming device. The method then displays at the intended image-forming device a location of the alternate image-forming device to which the image-forming-related job has been routed.

### BACKGROUND

In many organizational environments, there are a number of image-forming devices, such as printers. Typically, a user's print jobs have a default printer to which they are automatically routed. However, the default printer may not be able to process the user's jobs at certain times. The default printer may not be currently operational. It may also not have the capability to print a given user's job. For instance, the default printer may be black and white, whereas the user requested that the print job print in color.

In some environments, print jobs may be rerouted to less busy printers to increase overall throughput. In such cases, the print job may be routed to another nearby printer for completion. Typically, the user is informed at his or her computer that the print job has been routed to another printer. However, the user may have already left his or her desk to obtain the output of the print job from the default printer. The user may then wait in vain for the print job at the default printer. At some point, the user is likely to be forced to go back to his or her computer to see where the print job has been output. This can be an inconvenient, inefficient, and frustrating process.

### SUMMARY

A method of an embodiment of the invention routes an image-forming-related job from an intended image-forming device to an alternate image-forming device. The method then displays, at the intended image-forming device, a location of the alternate image-forming device to which the image-forming-related job has been routed.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method according to an embodiment of the invention.

FIG. 2 is a flowchart of a method that is more specific than, but consistent with, the method of FIG. 1, for performance by an image-forming device, according to an embodiment of the invention.

FIG. 3 is a flowchart of a method that is more specific than, but consistent with, the method of FIG. 1, for performance by an image-forming device server, according to an embodiment of the invention.

FIG. 4 is a diagram of a system according to an embodiment of the invention.

FIG. 5 is a block diagram of an image-forming device according to an embodiment of the invention, which can be used within the system of FIG. 4.

FIG. 6 is a block diagram of an external display device for the image-forming device of FIG. 5, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized and logical, mechanical, and other changes may be made without departing from the spirit or scope of the present invention. The following detailed description is, therefore, not to be taken in a limiting sense, and the scope of the present invention is defined only by the appended claims.

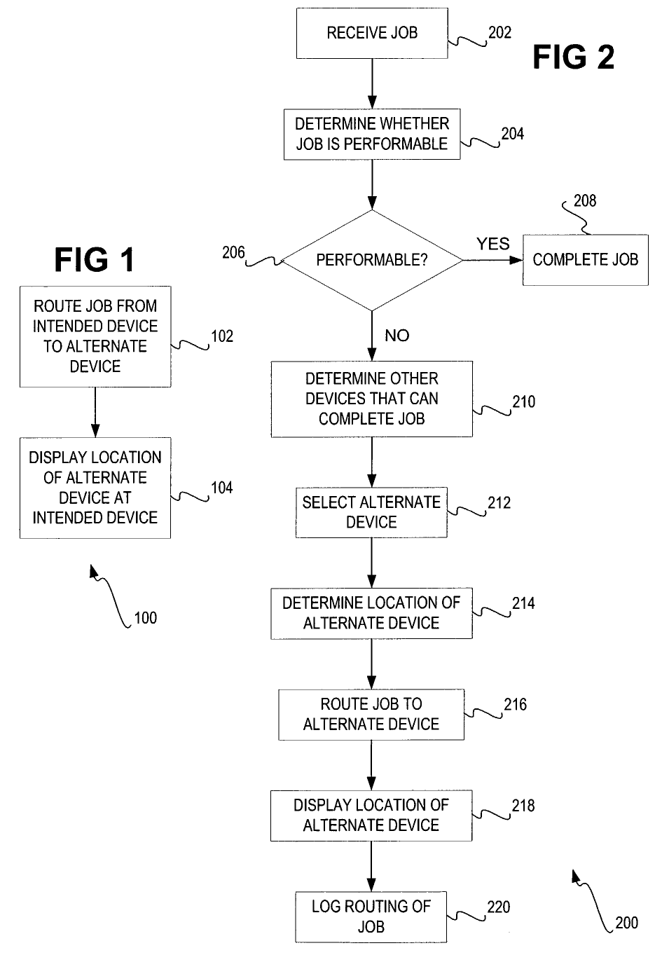

FIG. 1 shows a general method 100, according to an embodiment of the invention. Like other methods of embodiments of the invention, the method 100 may be implemented as a computer program or computer-executable instructions stored on a computer-readable medium, such as a fixed or removable medium, a volatile or non-volatile medium, and so on. The method 100 may be performed by an image-forming device, such as a printer, by an image-forming device server, such as a printer server, host computer, or by another type of device.

An image-forming-related job is routed from an intended image-forming device to an alternate image-forming device (102). The image-forming-related job may be a print job, such as a file, like a document file, an image file, and so on, that a user selected at his or her computer for output by the intended image-forming device. Each of the intended image-forming devices and the alternate image-forming devices may be a printer, such as a laser printer, an inkjet printer, and so on.

The job may have been routed from the intended device to the alternate device for a number of different reasons. The intended device may not have been able to complete the job. For example, the intended device may be currently inoperable for reasons such as lack of paper or other media, lack of toner or ink, loss of power or device turned off, or due to it malfunctioning. Also, the default device may not be able to print the job due to media size or type limitations. As another example, the job may have been requested to be output in color, whereas the intended device outputs only in black and white. The intended device may also not be as suitable to complete the job as the alternate device. For example, the job may encompass the printing of a large number of pages, whereas the intended device is relatively slow in performance or higher in cost, and the alternate device is relatively fast or less costly in performance. The job may have been rerouted to a less busy printer to increase overall throughput by load balancing across multiple machines. It is to be understood that print jobs may be rerouted for other reasons as well.

The location of the alternate image-forming device is displayed at the intended image-forming device (104). Thus, when the user travels to the location of the intended image-forming device to pick up the output of the image-forming-related job, he or she is able to quickly learn that the job has been routed to the alternate image-forming device, as well as learn the location of the alternate device. The location of the alternate device may be displayed on an integrated display of the intended device.

Such a display may also be used to display other information regarding the intended device or be reserved for displaying the locations of alternate devices to which jobs originally sent to the intended device have been routed. The display may be external to the intended device as well, which allows for extra functionality on a limited or non-existent integrated display. As another alternative, the display of the location of the alternate image-forming device at the intended image-forming device may be accomplished by outputting a sheet of media indicating the location of the alternate device, where the intended device is operational for such purposes.

FIG. 2 shows a method 200 for specific performance by an intended image-forming device, according to an embodiment of the invention. As can be appreciated by those of ordinary skill within the art, some parts of the method 200 may be performed in an order different than that which is depicted in FIG. 2. The intended image-forming device receives an image-forming-related job (202). The intended device determines whether it can perform this job (204). This determination can entail whether the intended device is capable of completing the job and/or whether the intended device is most suitable for completing the job. That is, the term performable encompasses both whether a device is capable of completing a job and/or whether the device is most suitable for completing the job.

As has been described, the intended device may not be capable of completing the job where it is currently inoperable or does not have the necessary capability to complete the job, such as color-printing capability, and so on. As has also been described, the intended device may not be as able to complete the job as other image-forming devices. For instance, it may be a relatively slow printer or have more jobs in its queue than other printers in the system. If the image-forming job encompasses the printing of a large number of pages or the rendering of complex pages, a faster image-forming device may be more suitable for, and thus more able to, complete the job.

If the image-forming-related job is performable within the meaning of this term as used herein (206), then the intended image-forming device completes the job (208), and the method 200 is finished. Otherwise, the intended device determines other image-forming devices that can complete the job (210). The intended device may, for instance, query other image-forming devices to learn whether they are capable or more able to complete the job. In one embodiment, the intended device may only query other image-forming devices that are nearby, so that the user does not have to travel far to pick up the output of the image-forming-related job from a device other than the intended device. The method 200 assumes that other image-forming devices that can complete the job exist, although those of ordinary skill within the art can appreciate that in some instances, this may not be true.

An alternate image-forming device to which to route the job is then selected from these other devices (212). Selection can be accomplished by the intended device itself or through user interaction. In the latter case, for instance, the user may be provided, at a display of the intended device, with a list of other image-forming devices to which his or her job can be routed. The user then is able to use a control panel of the intended device to select which of these other devices to which the user wishes to route the job, as the alternate image-forming device. Although not shown in FIG. 2, in the case where the user manually selects which device to reroute a job to, the selection of alternate devices might be displayed on both the device and the user's computer, allowing the user to reroute their job from either location.

The location of the alternate image-forming device is determined (214). For example, this can be accomplished by the intended device querying the alternate device as to its location. Such querying may be accomplished when the intended image-forming device had determined the other devices that can complete the image-forming-related job, in 210. The image-forming-related job is then routed to the alternate image-forming device (216) and the location of the alternate device displayed at the intended device (218), as has been described.

The routing of the job from the intended image-forming device to the alternate image-forming device may also be logged (220), for later administrator review. For instance, an administrator may be able to call up the history of job routings from the intended image-forming device on an embedded web server of the intended device, or have the intended device output the log. This enables the administrator to learn whether the intended image-forming device has the appropriate capabilities for the users whose jobs default to the output at the intended device. The administrator may learn, for example, that many users generate image-forming-related jobs that involve transparent media, whereas the intended device does not handle such media. The intended device may then be upgraded or replaced to better meet the users' needs. Alternatively, the administrator may block image-forming devices for job routing that are too great a distance from the default device, too expensive to use, or which are reserved for other types of output.

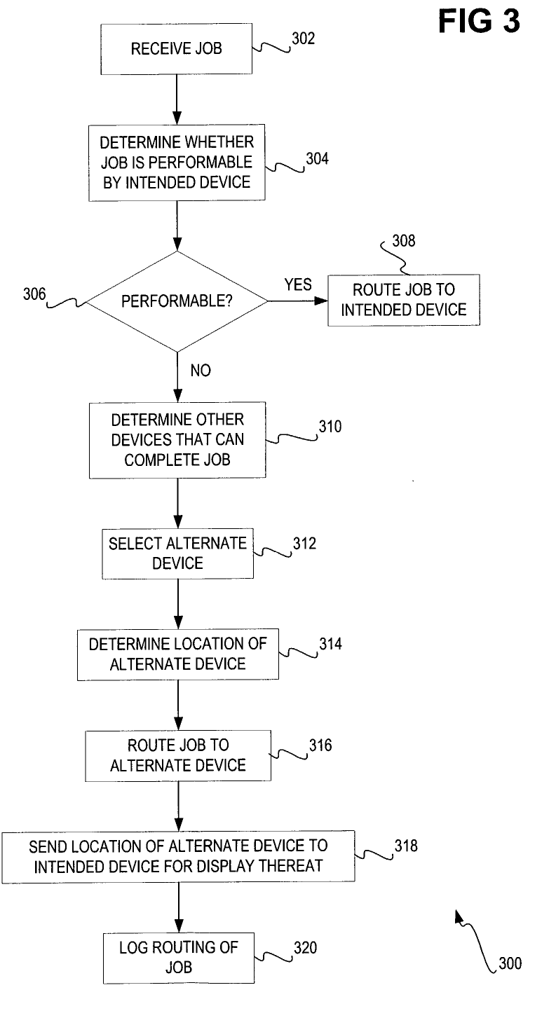

FIG. 3 shows a method 300 for specific performance by an image-forming device server, according to an embodiment of the invention. The server may be a print server that handles job routing for a number of different printers, for instance. As can be appreciated by those of ordinary skill within the art, some parts of the method 300 may be performed in an order other than that depicted in FIG. 3. The server receives an image-forming-related job for an intended image-forming device (302). The server determines whether the intended device can perform this job (304). As has been described, such determination can entail whether the intended device is capable of completing the job and/or whether the intended device is most suitable for completing the job.

If the image-forming-related job is performable within the meaning of this term as used herein (306), then the job is routed to the intended image-forming device (308), and the method 300 is finished. Otherwise, the server determines other image-forming devices that can complete the job (310). The server may, for instance, query other image-forming devices, such as perhaps only nearby such devices, to learn whether they are capable or more able to complete the job, or would likely complete the job more quickly. The server may also look up the capabilities of such image-forming devices in a database maintained by the image-forming device server or elsewhere. An alternate image-forming device to which to route the job is selected from these other devices by the server (312).

The location of the alternate image-forming device is determined (314). The location may be determined by querying the alternate device, as may have already been accomplished in 304 or in 310 or it may be determined by looking up this information in a database stored on the image-forming device server or at a remote location, as also may have already been accomplished in 304 or in 310. The image-forming-related job is then routed to the alternate image-forming device (316), whereas the location of the alternate device is sent to the intended image-forming device (318), so that the location may be displayed at the intended device. The routing of the image-forming-related job is logged (320), for later administrator analysis, as has been described.

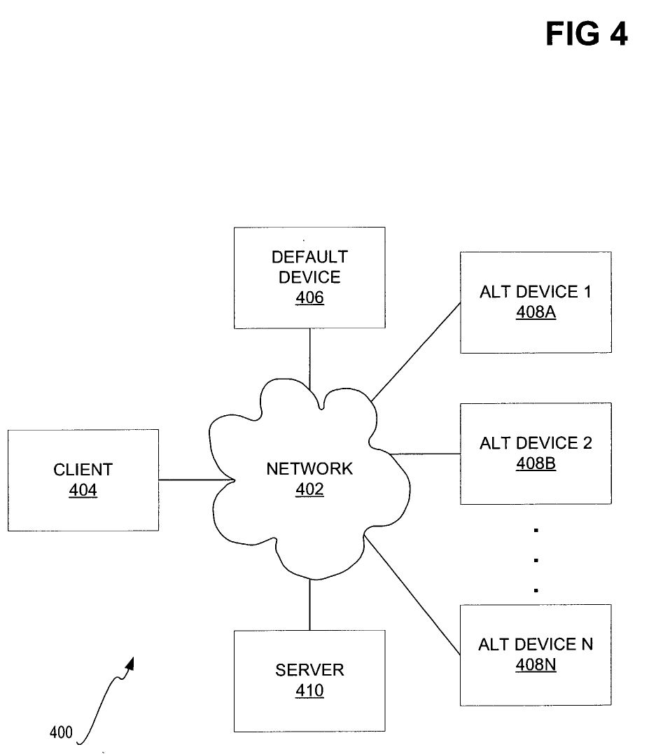

FIG. 4 shows a system 400 according to an embodiment of the invention. The system 400 includes a network 402, such as one or more of a local-area network (LAN), a wide-area network (WAN), a wired network, a wireless network, an intranet, an extranet, the Internet, and so on. Communicatively coupled to the network 402 are a client computing device 404, a default image-forming device 406 for the client computing device 404, and a number of alternate image-forming devices 408A, 408B, . . . , 408N, the latter which are collectively referred to as the alternate image-forming devices 408. Optionally communicatively coupled to the network 402 is an image-forming device server 410.

The client computing device 404 and the image-forming device server 410 may each be a computer, such as a desktop computer. Each of the default image-forming device 406 and the alternate image-forming devices 408 may be a printer, such as a laser printer, an inkjet printer, digital copier and so on. A user generates an image-forming-related job at the client 404 intended for output by the default device 406. The job may be directly transmitted by the client 404 to the default device 406 or alternatively may be initially transmitted to the server 410.

In the former instance, if the default device 406 determines that it is unable or less suitable to complete the image-forming-related job, then it routes the job to one of the alternate devices 408, as has been described. The default device 406 then displays the location of the alternate device to which it has routed the job. In the latter instance, if the server 410 determines that the default device 406 is unable or less suitable to complete the image-forming-related job, then it routes the job to one of the alternate devices 408, as has been described. The server 410 then sends the location of the alternate device to which it has routed the job to the default device 406 for display.

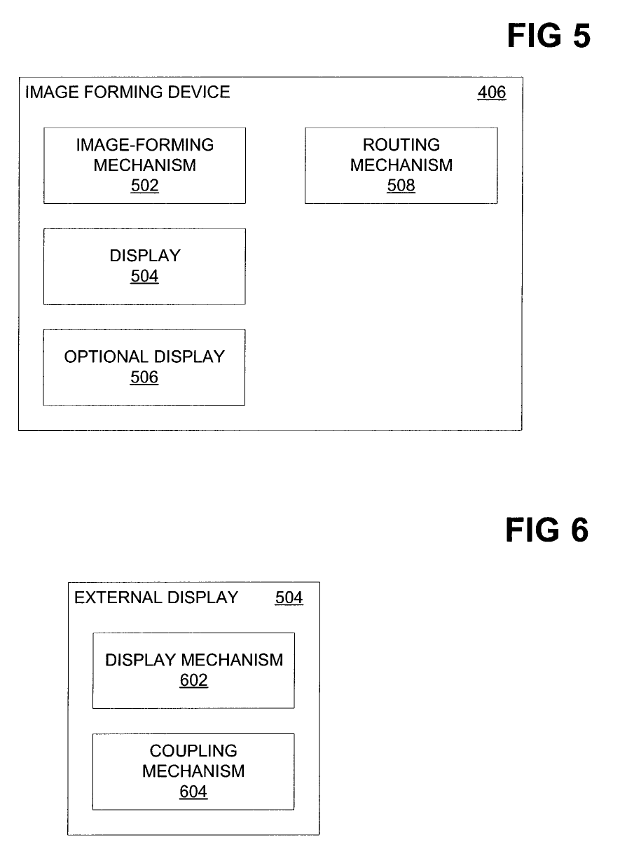

FIG. 5 shows the image-forming device 406 in more detail, according to an embodiment of the invention. The image-forming device 406 specifically includes at least an image-forming mechanism 502 and a display 504. The image-forming mechanism 502 is that which actually outputs image-forming-related jobs. For example, the mechanism 502 may be a laser printing mechanism, an inkjet printing mechanism, and so on. The display 504 displays at least the locations of alternate image-forming devices to which image-forming-related jobs intended for output by the device 406 have been routed. The display 504 may be an external or internal display, such as a liquid-crystal display (LCD).

Where the optional display 506 is present within the device 406, in which case the optional display 506 would in fact be the primary display for the device 406, the display 504 would then be a secondary display and may exclusively display only the locations of alternate devices to which jobs intended for the device 406 have been routed. The display 506 in this embodiment then displays other information regarding the device 406, such as general status information, consumables information, and so on. In the embodiment where the display 506 is not present, then the display 504 may be the primary display and handle both these functions, displaying the locations of alternate devices to which jobs intended for the device 406 have been routed, as well as other information regarding the device 406. In still another embodiment where the display 506 is not present, the display 504 is a dedicated display that only displays the locations of alternate devices to which the jobs have been routed.

The routing mechanism 508 is desirably present and/or functional within the device 406 when the system of which the device 406 is a part does not include an image-forming device server, such as the server 410 of FIG. 4. The routing mechanism 508 performs the determination of alternate image-forming devices to which jobs intended for the image-forming device 406 can be routed where the device 406 is unable or less suitable to complete such jobs. The routing mechanism 508 determines the locations of such alternate devices, as has been described. The mechanism 508 is said to selectively route jobs intended for the image-forming device 406, since not all jobs intended for the device 406 will be routed to alternate devices. The mechanism 508 can be software, hardware, or a combination of software and hardware, and can be considered the means for performing its functionality. In the embodiment where the image-forming device server is present, the mechanism 508 may alternatively be located within the server.

FIG. 6 shows the display 504 of the image-forming device 406 of FIG. 5 in more detail, in an embodiment of the invention where the display 504 is an external display device to the image-forming device 406. The external display 504 includes a display mechanism 602 and a coupling mechanism 604. The display mechanism 602 is that which actually displays the locations of the alternate image-forming devices to which image-forming-related jobs intended for the image-forming device 406 have been routed. The display mechanism 602 can be an LCD, for instance.

The coupling mechanism 604 communicatively couples the display 504 to the image-forming device 406. The mechanism 604 thus allows the display 504 to receive from the image-forming device 406 the locations of the alternate image-forming devices to which jobs intended for the device 406 have been routed, for presentation on the display 602. The coupling mechanism 604 can be a wired or a wireless mechanism, such as a serial cable, a Universal Serial Bus (USB) cable, an extended input/output (EIO) card, an 802.11 b or a Bluetooth wireless transceiver, and so on.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

We claim:

1. A method comprising:
routing an image-forming-related job from an intended image-forming device to an alternate image-forming device; and,
displaying at the intended image-forming device a location of the alternate image-forming device to which the image-forming-related job has been routed.

2. The method of claim 1, further initially comprising:
receiving the image-forming-related job at the intended image-forming device; and,
determining by the intended image-forming device that the intended image-forming device is unable to complete the image-forming-related job,
wherein routing the image-forming-related job is performed by the intended image-forming device.

3. The method of claim 1, further initially comprising:
receiving the image-forming-related job at the intended image-forming device; and,
determining by the intended image-forming device that the alternate image-forming device is more able to complete the image-forming-related job than the intended image-forming device,
wherein routing the image-forming-related job is performed by the intended image-forming device.

4. The method of claim 1, further initially comprising:
receiving the image-forming-related job at an image-forming device server;
determining by the image-forming device server that the intended image-forming device is unable to complete the image-forming-related job; and,
sending to the intended image-forming device the location of the alternate image-forming device for display thereat,
wherein routing the image-forming-related job is performed by the image-forming device server.

5. The method of claim 1, further initially comprising:
receiving the image-forming-related job at an image-forming device server;
determining by the image-forming device server that the alternate image-forming device is more able to complete the image-forming-related job than the intended image-forming device; and,
sending to the intended image-forming device the location of the alternate image-forming device for display thereat,
wherein routing the image-forming-related job is performed by the image-forming device server.

6. The method of claim 1, further initially comprising querying the alternate image-forming device to determine that the alternate image-forming device is able to complete the image-forming-related job.

7. The method of claim 1, further initially comprising:
determining which of a plurality of other image-forming devices can complete the image-forming-related job; and,
selecting the alternate image-forming device from those of the plurality of other image-forming devices that can complete the image-forming-related job.

8. The method of claim 7, wherein determining which of the plurality of other image-forming devices can complete the image-forming-related job comprises determining which of the plurality of other image-forming devices can complete the image-forming-related job and are nearby the intended image-forming device.

9. The method of claim 7, wherein determining which of the plurality of other image-forming devices can complete the image-forming-related job comprises querying the plurality of other image-forming devices to determine which of the plurality of other image-forming devices can complete the image-forming-related job.

10. The method of claim 7, wherein selecting the alternate image-forming device comprises having a user select the alternate image-forming device at the intended image-forming device.

11. The method of claim 1, further comprising, prior to displaying at the intended image-forming device the location of the alternate image-forming device, querying the alternate image-forming device for the location of the alternate image-forming device.

12. The method of claim 1, further comprising logging by the intended image-forming device a history of routings from the intended image-forming device, including routing of the image-forming-related job to the alternate image-forming device, for later administrator analysis.

13. The method of claim 1, wherein displaying at the intended image-forming device the location of the alternate image-forming device comprises displaying the location of the alternate image-forming device on one of an integrated display of the intended image-forming device and an external display of the intended image-forming device.

14. A computer-readable medium having instructions stored thereon to perform a method comprising:
receiving an image-forming-related job intended for an intended image-forming device;
in response to one of determining that the intended image-forming device is unable to complete the image-forming-related job and determining that an alternate image-forming device is more able to complete the image-forming-related job,
routing the image-forming-related job to the alternate image-forming device that is able to complete the image-forming-related job;
displaying at the intended image-forming device a location of the alternate image-forming device to which the image-forming-related job has been routed.

15. The medium of claim 14, further comprising, otherwise, performing the image-forming-related job at the intended image-forming device, the method performed by the intended image-forming device.

16. The medium of claim 14, further comprising, otherwise, routing the image-forming-related job to the intended image-forming device, the method performed by a device other than the intended image-forming device.

17. The medium of claim 14, further comprising, prior to displaying at the intended image-forming device the location of the alternate image-forming device, querying the alternate image-forming device for the location of the alternate image-forming device.

18. The medium of claim 17, further comprising, prior to displaying at the intended image-forming device the location of the alternate image-forming device, sending the location of the alternate image-forming device to the intended image-forming device for display thereat.

19. An image-forming device comprising:
an image-forming mechanism on which image-forming-related jobs are output; and,
a display on which to display at least locations of alternate image-forming devices to which image-forming-related jobs intended for the image-forming device have been routed.

20. The device of claim 19, further comprising a primary display to display information other than the locations of alternate image-forming devices to which image-forming-related jobs intended for the image-forming device have been routed, the display on which the locations of alternate image-forming-devices to which image-forming-related jobs intended for the image-forming device have been routed displaying only the locations.

21. The device of claim 19, further comprising a controller to route image-forming-related jobs intended for the image-forming device to alternate image-forming devices where the image-forming device is unable to complete the image-forming-related jobs.

22. The device of claim 19, further comprising a controller to route image-forming-related jobs intended for the image-forming device to alternate image-forming devices where the alternate image-forming devices are more able to complete the image-forming-related jobs than the image-forming device.

23. The device of claim 19, further comprising a controller to receive from an image-forming device server the locations of alternate image-forming devices to which image-forming-related jobs intended for the image-forming device have been routed.

24. The device of claim 19, wherein the display is one of external and internal to the image-forming device.

25. The device of claim 19, wherein the image-forming mechanism is one of a laser-printing mechanism and an inkjet-printing mechanism.

26. A external display device for an image-forming device comprising:
a coupling mechanism to communicatively couple the display device to the image-forming device to receive from the image-forming device locations of alternate image-forming devices to which image-forming-related jobs intended for the image-forming device are routed; and,
a display mechanism to display the locations of alternate image-forming devices to which image-forming-related jobs intended for the image-forming device have been routed.

27. The device of claim 26, wherein the coupling mechanism comprises one of a wired coupling mechanism and a wireless coupling mechanism.

28. A system comprising:
an image-forming device having a display;
at least one alternate image-forming device; and,
a mechanism to determine locations of the at least one alternate image-forming device to which image-forming-related jobs have been selectively routed from the image-forming device, for presentation on the display of the image forming device.

29. The system of claim 28, further comprising an image-forming device server of which the mechanism is a part, the mechanism sending the locations to the image-forming device for display on the display thereof.

30. The system of claim 28, wherein the mechanism is part of the image-forming device.

31. A system comprising:
an image-forming device having a display;
at least one alternate image-forming device; and,
means for determining locations of the at least one alternate image-forming device to which image-forming-related jobs have been selectively routed from the image-forming device, for display on the display of the image forming device.

32. The system of claim 31, further comprising an image-forming device server of which the means is a part.

33. The system of claim 31, wherein the means is part of the image-forming device.
